(19) United States
(12) Patent Application Publication
(10) Pub. No.: US 2008/0220230 A1
(43) Pub. Date: Sep. 11, 2008

(54) Process For the Fractionation of Mixtures of Phthalocyanine Dyes

(75) Inventors: Graham Michael Watson, Stirlingshire (GB); Jill Louise Johnson, Stirlingshire (GB); Prakash Patel, Manchester (GB); William Albert Fern, Manchester (GB)

Correspondence Address: MORGAN LEWIS & BOCKIUS LLP, 1111 PENNSYLVANIA AVENUE NW, WASHINGTON, DC, 20004, US

(73) Assignee: AVECIA INKJET LIMITED, Manchester (GB)

(21) Appl. No.: 10/585,735

(22) PCT Filed: Nov. 24, 2004
(86) PCT No.: PCT/GB04/04950

§ 371 Date: Mar. 19, 2008

(30) Foreign Application Priority Data
Jan. 23, 2004 (GB) 0401540.0

(51) Int. Cl. B41M 5/00; C09D 11/02; G01D 11/00; B05D 5/04

(52) U.S. Cl. 428/211.1; 106/31.49; 427/288; 428/195.1; 347/100

(57) ABSTRACT

Process for forming an image on a substrate comprising applying an ink thereto by means of an ink-jet printer wherein the ink comprises a liquid medium and a phthalocyanine dye fraction obtainable by the fractionation of a solution and/or suspension of a mixture of phthalocyanine dyes of Formula (1), and salts thereof, by cross-flow filtration:

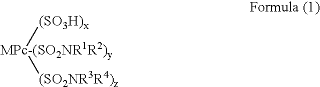

wherein:
M is 2H, copper or nickel;
Pc represents a phthalocyanine nucleus;
R¹ and R³ independently are H or optionally substituted C₁₋₄alkyl;
R² and R⁴ independently are H or optionally substituted hydrocarbyl; or
R¹ and R², and, R³ and R⁴, independently, together with the nitrogen atom to which they are attached represent an optionally substituted aliphatic or aromatic ring system;
x is 0 to 3.9;
y is 0 to 3.9;
z is 0.1 to 4; and
   the sum of (x+y+z) is 2.4 to 4.5.

This invention relates to an ink-jet printing process, to printed substrates, to ink-jet inks and to ink-jet printer cartridges.

Ink-jet printing is a non-impact printing technique in which droplets of ink are ejected through a fine nozzle onto a substrate without bringing the nozzle into contact with the substrate. With the advent of high-resolution digital cameras it is increasingly common for consumers to print photographs using an ink-jet printer. This avoids the expense of conventional silver halide photography and provides a print quickly and conveniently.

While ink-jet printers have many advantages over other forms of printing there are still technical challenges to be addressed. For example, there are the contradictory requirements of providing ink-colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer. Furthermore, the resultant images should not fade on exposure to light or common atmospheric oxidising gases such as ozone.

In colour ink-jet printing the various colours and tones are achieved by selectively printing with the different components of an ink-jet colour set. An ink-jet colour set usually comprises black, yellow, magenta and cyan inks. All of the cyan colourants currently used in ink-jet printing are phthalocyanine dyes. Phthalocyanine colourants have many of the properties required for use in ink-jet printing. However, when printed, they suffer from long term fade and shade changes brought about by trace atmospheric oxidising gases, such as ozone.

Commercial phthalocyanine dyes are complex mixtures containing numerous different phthalocyanines species that carry varying levels of substituents in different positions on the phthalocyanine ring system. We have surprisingly found that it is possible to fractionate these complex mixtures of phthalocyanine dyes using cross-flow filtration (a filtration process in which a solution is caused to flow across the surface of the filtration membrane) to provide phthalocyanine dye mixtures that provide prints with enhanced ozone stability.

The use of cross-flow filtration to remove impurities from dyes for use in ink-jet printing is known (U.S. Pat. No. 6,665,095). However, its use to fractionate complex mixtures of dyes so that a particular fraction with a desired property may be obtained is new.

The present invention provides a process for forming an image on a substrate comprising applying an ink thereto by means of an ink-jet printer wherein the ink comprises a liquid medium and a phthalocyanine dye fraction obtainable by the fractionation of a solution and/or suspension of a mixture of phthalocyanine dyes of Formula (1), and salts thereof, by cross-flow filtration:

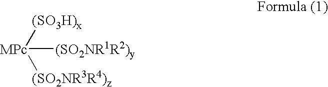

wherein:
M is 2H, copper or nickel;
Pc represents a phthalocyanine nucleus;
R¹ and R³ independently are H or optionally substituted C₁₋₄alkyl;
R² and R⁴ independently are H or optionally substituted hydrocarbyl; or
R¹ and R², and, R³ and R⁴, independently, together with the nitrogen atom to which they are attached represent an optionally substituted aliphatic or aromatic ring system;
x is 0 to 3.9;
y is 0 to 3.9;
z is 0.1 to 4; and
   the sum of (x+y+z) is 2.4 to 4.5.

In the process of the present invention the ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain, treated or coated papers which may have an acid, alkaline or neutral character. Glossy papers are especially preferred. More especially photographic quality paper is preferred.

Preferred inks comprise:

(a) from 0.01 to 10 parts of the phthalocyanine dye fraction; and

(b) from 90 to 99.99 parts of a liquid medium.

Preferred liquid media include water, a mixture of water and organic solvent and organic solvent free from water.

When the liquid medium comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol. When the liquid medium comprises a mixture of water and organic solvent or organic solvent free from water component (a) is preferably completely dissolved in component (b).

When the liquid medium comprises organic solvent free from water, (i.e. less than 1% water by weight) the solvent preferably has a boiling point of from 30° to 200° C., more preferably of from 40° to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the compound in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is organic solvent free from water it is a mixture of 2 to 5 different organic solvents. This allows a medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties. Examples of such colorants include C.I. Direct Yellow 86, 132, 142 and 173; C.I. Direct Blue 307; C.I. Food Black 2; C.I. Direct Black 168 and 195; and C.I. Acid Yellow 23.

The inks may be incorporated in an ink-jet printer as a high concentration cyan ink, a low concentration cyan ink or both a high concentration and a low concentration ink. In the latter case this can lead to improvements in the resolution and quality of printed images. Thus the present invention also provides a process where in the ink component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferably the ink has a viscosity of less than 25 cP, more preferably less than 10 cP, especially less than 5 cP, at 25° C. These low viscosity inks are particularly well suited for application to substrates by means of ink-jet printers.

Preferably the ink contains less than 500 ppm, more preferably less than 250 ppm, especially less than 100 ppm, more especially less than 10 ppm in total of divalent and trivalent metal ions (other than any divalent and trivalent metal ions bound to a component of the ink).

Preferably the ink has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably the ink contains less than 500 ppm, more preferably less than 250 ppm, especially less than 100 ppm, more especially less than 10 ppm in total of halide ions.

In a particularly preferred embodiment of the present invention the ink has a viscosity of less than 25 cP at 25° C.; contains less than 500 ppm in total of divalent and trivalent metal ions (other than any divalent and trivalent metal ions bound to a component of the ink); contains less than 500 ppm halide ions; and has been filtered through a filter having a mean pore size below 10 μm.

The phthalocyanine nucleus in the compounds of Formula (1) may be represented by the bivalent radical of formula:

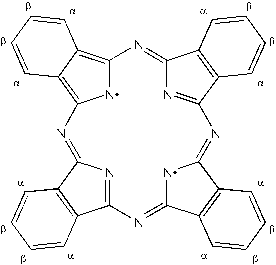

In one preferred embodiment the substituents; x, y and z are bound to the phthalocyanine nucleus only via the β-position.

M is preferably Cu or Ni and more preferably M is Cu.

R¹ and R³ may be either linear or branched alkyl. Preferably R¹ and R³ independently are H or methyl, more preferably R¹ and R³ are both H.

Preferably R² and R⁴ independently are H; optionally substituted alkyl, especially optionally substituted C₁₋₄-alkyl; optionally substituted alkenyl, especially optionally substituted C₁₋₄-alkenyl; optionally substituted alkynyl, especially optionally substituted C₁₋₄-alkynyl; optionally substituted aryl, especially optionally substituted phenyl or naphthyl; or optionally substituted heterocycyl.

When R² and R⁴ are optionally substituted alkyl, optionally substituted alkenyl or optionally substituted alkynyl they may independently be linear, branched or cyclic.

Preferably R² is H or methyl, more preferably H.

Thus, R¹, R² and R³ may all be H

Preferably R⁴ is optionally substituted alkyl, especially optionally substituted C₁₋₄-alkyl; optionally substituted aryl, especially optionally substituted phenyl or optionally substituted heterocycyl.

When R¹ and R², and, R³ and R⁴ together with the nitrogen atom to which they are attached represent an optionally substituted aliphatic or aromatic ring system then preferably, independently, they comprise an optionally substituted mono, bi or tricyclic aliphatic or aromatic ring. More preferably R¹ and R², and, R³ and R⁴ together with the nitrogen atom to which they are attached, independently, are optionally substituted 3 to 8 membered aliphatic or aromatic ring. It is especially preferred that R¹ and R², and R³ and R⁴ together with the nitrogen atom to which they are attached, independently, are optionally substituted 5- or 6-membered aliphatic or aromatic rings. The optionally substituted aromatic or aliphatic ring formed by R¹ and R², and, R³ and R⁴ together with the nitrogen atom to which they are attached may, independently, comprise at least one further hetero atom. Examples of preferred ring systems include imidazole, pyrazole, pyrrole, benzimidazole, indole, tetrahydro(iso)quinoline, decahydro(iso)quinoline, pyrrolidine, pyrroline, imidazolidine, imidazoline, pyrazolidine, pyrazoline, piperidine, piperazine, indoline, isoindoline, thiazolidine and morpholine.

Preferred optional substituents which may be present on R¹, R², R³ and R⁴ are independently selected from: optionally substituted alkoxy (preferably C₁₋₄-alkoxy), optionally substituted aryl (preferably phenyl), optionally substituted aryloxy (preferably phenoxy), optionally substituted heterocyclic, polyalkylene oxide (preferably polyethylene oxide or polypropylene oxide), carboxy, phosphato, sulfo, nitro, cyano, halo, ureido, —SO₂F, hydroxy, ester, —NR⁵R⁶, —COR⁵, —CONR⁵R⁶, —NHCOR⁵, carboxyester, sulfone, and —SO₂NR⁵R⁸, wherein R⁵ and R³ are each independently H or optionally substituted alkyl (especially C₁₋₄-alkyl). Optional substituents for any of the substituents described for R¹, R², R³ and R⁴ may be selected from the same list of substituents.

In the compound of Formula (1) the sum of (x+y+z) is preferably 3.5 to 4.5, more preferably the sum of (x+y+z) is 3.8 to 4.2 and especially the sum of (x+y+z) is 4.0.

The values for x, y and z in compounds of Formula (1) all represent statistical averages, reflecting the fact that the compounds of Formula (1) are a complex mixture.

In one preferred embodiment R¹, R², and, R³ are all H and R⁴ is hydroxyethyl.

In another preferred embodiment R³ is H, R⁴ is carboxyphenyl and y is 0.

In a third preferred embodiment R³ and R⁴ are both H and y is 0.

The compounds of Formula (1) may be prepared by condensing phthalocyanines, preferably copper or nickel phthalocyanines, carrying sulfonyl chloride groups and optionally sulfonic acid groups with compounds of formula HNR¹R² and HNR³R⁴ wherein R¹, R², R³ and R⁴ are as hereinbefore defined. The condensation is preferably performed in water at a pH above 7. Typically the condensation is performed at a temperature of 30 to 70° C. and the condensation is usually complete in less than 24 hours. The compounds of formula HNR¹R² and HNR³R⁴ may be used as a mixture or condensed sequentially with the said phthalocyanine compound. Many compounds of formula HNR¹R² and HNR³R⁴ are commercially available, for example; ammonia, ethanolamine and morpholine others may be readily prepared by a skilled person.

Copper and nickel phthalocyanines carrying sulfonyl chloride groups and optionally sulfonic acid groups may be prepared by chlorosulfonating copper or nickel phthalocyanine, e.g. using chlorosulfonic acid and optionally a chlorinating agent (e.g. POCl₃, PCl₅ or thionylchloride).

When the substituents are bound to the phthalocyanine nucleus only via the β-position then the phthalocyanine dyes of Formula (1) are prepared by cyclisation of appropriate β-sulfo substituted phthalic acid, phthalonitrile, iminoisoindoline, phthalic anhydride, phthalimide or phthalamide, optionally in the presence of a suitable metal salt, such as CuCl₂, followed by chlorination and then amination/amidation as described above.

Preferably phthalocyanine dyes of Formula (1) where the sulfo and sulfonamide substituents are attached to a β-position on the phthalocyanine ring are prepared by cyclisation of 4-sulfophthalic acid, in the presence of a suitable copper salt such as CuCl₂, to give phthalocyanine β-tetrasulfonic acid which may then be chlorinated and aminated/amidated as described above.

The compounds of Formula (1) are also preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye.

Acid or basic groups on the compounds of Formula (1), particularly acid groups, are preferably in the form of a salt. Thus, the Formulae shown herein include the compounds in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. Compounds of Formula (1) may be converted into a salt using known techniques.

The compounds of Formula (1) may exist in tautomeric forms other than those shown in this specification. These tautomers are included within the scope of the present invention.

The phthalocyanine dye mixtures may be in solution/suspension in any liquid medium. Preferably the phthalocyanine dye mixture is substantially in solution in a medium that comprises water. In one embodiment the phthalocyanine dye mixture is substantially in solution in an ink medium as described above.

Any suitable cross-flow filtration apparatus may be used to fractionate the phthalocyanine dye mixture.

The cross-flow filtration membrane used in the process of the invention can be any membrane that is suitable for use in cross-flow filtration. Materials from which the membrane can be constructed include porous polymeric materials, porous metals and porous ceramics. Membranes made from polymeric materials such as polysulfones are particularly effective in the present invention.

Either ultrafiltration or microfiltration membranes may be used. However, it is preferred that in the process of the present invention that the cross-flow filtration membrane is an ultrafiltration membrane.

The pore size of the ultrafiltration membrane used in the process of the present invention preferably has a nominal molecular weight cut-off in the range of from 5,000 to 500,000 Daltons. More preferably the membrane has a nominal molecular weight cut-off in the range of from 10,000 to 200,000 Daltons. It is especially preferred that the membrane has a nominal molecular weight cut-off in the range of from 20,000 to 100,000 Daltons.

Depending on the membrane and conditions used and the nature of the mixture of phthalocyanine dyes the desired phthalocyanine fraction may be in either the filtration concentrate or permeate. Preferably the desired phthalocyanine fraction is in the concentrate.

The cross-flow filtration may utilise several membranes with a different pore size and solution may be recycled during the filtration process. Additional solvent, especially water, may be added during the filtration process to replace the permeate lost from the flow stream, this process is also known as diafiltration.

Preferably the filtration device used allows cross-flow filtration through a series of 2 or more, preferably different, membranes. When this is the case then preferably the phthalocyanine dye mixture is first passed over a low nominal molecular weight cut-off membrane and then the concentrate is passed over membranes of increasing nominal molecular weight cut-off.

Mechanical vibration of the surface of the cross-flow filtration membrane can be used to enhance the effect of the flowing medium.

The process of the invention may be operated with a pressure in excess of atmospheric pressure applied to the suspension, preferred pressures are in the range of 1 to 10 bar, more preferably 1 to 3 bar

The velocity of flow of the solution across the surface of the membrane will depend upon the construction of the filtration system used and the nature of the membrane. In a laboratory-scale apparatus in which a polysulfone membrane is used in the form of a flat sheet a cross-flow velocity above 2 litres per minute has been found to be effective. Larger initial cross-flow velocities, above 5 litres per minute and especially above 10 litres per minute have been found useful for larger scale equipment.

Equipment which is suitable for use in the cross-flow filtration process of the present invention may be purchased from, for example, Alfa Laval or Armfield Ltd.

A second aspect of the present invention provides a printed substrate, preferably paper, plastic, a textile, metal or glass, obtainable by means of a process according to the first aspect of the invention. More preferably the printed substrate comprises paper. Preferred papers are plain, treated or coated papers which may have an acid, alkaline or neutral character. Glossy papers are especially preferred. More especially photographic quality paper is preferred.

It is especially preferred that the second aspect of the invention is a photographic quality print.

A third aspect of the present invention provides an ink-jet printing ink that comprises:

(i) a phthalocyanine dye fraction obtainable by the fractionation of a solution and/or suspension of a mixture of phthalocyanine dyes of Formula (1), and salts thereof, by cross-flow filtration:

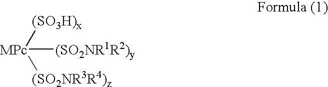

wherein:
M is 2H, copper or nickel;
Pc represents a phthalocyanine nucleus;
R¹ and R³ independently are H or optionally substituted C₁₋₄alkyl;
R² and R⁴ independently are H or optionally substituted hydrocarbyl; or
R¹ and R², and, R³ and R⁴, independently, together with the nitrogen atom to which they are attached represent an optionally substituted aliphatic or aromatic ring system;
x is 0 to 3.9;
y is 0 to 3.9;
z is 0.1 to 4; and
the sum of (x+y+z) is 4; and

(ii) a liquid medium:

wherein the ink has a viscosity of less than 20 cP at 25° C.; contains less than 500 ppm in total of divalent and trivalent metal ions (other than any divalent and trivalent metal ions bound to a component of the ink); contains less than 500 ppm halide ions; and has been filtered through a filter having a mean pore size below 10 μm.

The phthalocyanine dyes and liquid medium are as described and preferred in the first aspect of the invention.

A fourth aspect of the present invention provides an ink-jet printer cartridge comprising a chamber and an ink wherein the ink is in the chamber and the ink is as defined in the first or third aspects of the present invention. Preferably the cartridge contains high concentration ink and low concentration ink, as described above, in different chambers.

The invention is further illustrated by the following Examples in which all parts and percentages are by weight unless otherwise stated.

### EXAMPLE 1

Ultrafiltration was carried out using a plate and frame membrane unit (Model DDS Lab Unit M20 from Danish Separation Systems AS) with polysulfone or polyethersulfone membranes. The membranes are characterised by their nominal molecular weight cut off (MWCO) and were obtained from Alfa Lavel Ltd. Details of the membranes used are given in Table 1.

TABLE 1
Membranes used for Ultrafiltration studies in the DDS M20 unit

| | | Typical | Water |
|---|---|---|---|
| Designation | Characteristics | MWCO | flux rate lt/(hr m²)¹ |
| GR40PP | Polysulfone | 100,000D | 300-600 |
| GR51PP | Polysulfone | 50,000D | 275-525 |
| GR60PP | Polysulfone | 25,000D | 250-450 |
| GR61PP | Polysulfone | 20,000D | 275-475 |
| GR81PP | Polyethersulfone | 10,000D | 100-325 |

### Dye 1

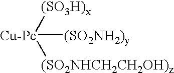

Dye 1 was obtained using the method as described in Example 1 of International Patent Application WO99/67334. Following the synthesis, analysis revealed that x was 1.8 and (y+z) was 1.6

### Fractionation of Dye 1

A solution of Dye 1 (173 g in 10 litres of water) was passed over the 20,000 Dalton MWCO membrane and recycled until no dye was present in the permeate stream, water was added throughout the process so that the volume of the dye solution was essentially constant. The resultant concentrate was then passed over the 50,000 Dalton MWCO membrane, recycling and maintaining an essentially constant volume by the addition of water until no dye was present in the permeate stream. The concentrate from the 50,000 Dalton MWCO membrane was then passed over the 100,000 Dalton MWCO membrane, recycling and maintaining an essentially constant volume as described above until no dye appeared in the permeate stream. The conditions used are shown in Table 2.

TABLE 2
Summary of the fractionation process conditions of Dye 1
in the DDS M20 unit

| Membrane | 20 kD | 50 kD | 100 kD |
|---|---|---|---|
| Membrane Surface area (m²) | 0.18 | 0.216 | 0.18 |
| Time processing (hr) | 14:31 | 4:47 | 2:48 |
| Average Temperature (° C.) | 19.9 | 19.1 | 15.9 |
| Inlet operating pressure (bar) | 4 | 4 | 3 |
| Initial mass (g) in each stage | 173 | 119 | 26 |
| Water flux rate - initial (litre/hr m²) | 301.1 | 342.6 | 413.3 |
| Average flux rate cyan (litre/hr m²) | 120.0 | 129.2 | 171.7 |
| Water flux rate - final (litre/hr m²) | 164.3 | 258.8 | 303.3 |

### Preparation of Inks

Dye 1, prior to cross-flow filtration, (Comparative Ink 1) and the final concentrate of Dye 1 from the 50,000 Dalton filter (Ink 1) and the 100,000 Dalton filter (Ink 2) were converted into inks by dissolving 3 g of dye in a liquid medium comprising:

| | |
|---|---|
| Thiodiglycol | 5% |
| 2-Pyrollidone | 5% |
| Surfynol ™ 465 | 1% |
| Water | 89% (all % by weight) |

and adjusting the pH of the ink to pH 8 with sodium hydroxide.

An ink of this composition as prepared would be expected to have a viscosity of between 1 to 3 cP, contain less than 500 ppm in total of divalent and trivalent metal ions (other than any divalent and trivalent metal ions bound to a component of the ink) and contain less than 500 ppm halide ions. Surfynol™ 465 is a surfactant from Air Products Ltd.

### Ink-Jet Printing

Inks 1 and 2 and the Comparative Ink 1 were filtered through 0.45 micron nylon filters and then incorporated into empty print cartridges using a syringe.

The inks were then printed onto EPSON Premium Glossy Photo paper (“SEC PM”) and Canon Premium PR101 (“PR101”). The resultant prints at 100% were tested for ozone fastness by exposure to 1 ppm ozone at 40° C., 50% relative humidity for 24 hrs in a Hampden 903 Ozone Cabinet.

Ozone-fastness of the printed image is expressed in terms of % ROD loss, where the lower the % ROD loss the greater the ozone fastness, and as degree of fade. The degree of fade is expressed as ΔE, where a lower figure indicates higher ozone fastness. ΔE is defined as the overall change in the CIE colour co-ordinates L, a, b of the print and is expressed by the equation ΔE=(ΔL²+Δa²+Δb²)^{0.5}.

TABLE 3

| | ΔE | % ROD Loss | ΔE | % ROD Loss |
|---|---|---|---|---|
| Ink | PR101 | PR101 | SEC PM | SEC PM |
| Ink 1 | 38 | 41% | 20 | 27% |
| Ink 2 | 32 | 31% | 16 | 17% |
| Comparative Ink 1 | 48 | 52% | 23 | 34% |

Table 3 shows that the process of the present invention yields prints that have an improved stability to ozone.

### EXAMPLE 2

### Dye 2

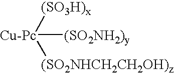

Dye 2 was obtained using the method as described in Example 1 of International Patent Application WO WO99/67334. Following the synthesis, analysis revealed that x was 1.8 and (y+z) was 1.8

### Fractionation of Dye 2

Dye 2 was filtered using the DDS M20 filtration unit. A solution of the dye (1.7%) was passed successively over 50,000 Dalton and 100,000 Dalton MWCO membranes, as described in Example 1. The conditions used are shown in Table 4.

TABLE 4
Summary of the fractionation process conditions of Dye 2
in the DDS M20 unit

| Membrane | 50 kD | 100 kD |
|---|---|---|
| Membrane Surface area (m²) | 0.216 | 0.18 |
| Time processing (hr) | 10:20 | 06:18 |
| Average Temperature (° C.) | 19.5 | 19.9 |
| Inlet operating pressure (bar) | 4 | 3 |
| Initial mass (g) in each stage | 197.4 | 60.3 |
| Water flux rate - initial (lt/hr m²) | 364.4 | 488.3 |
| Average flux rate cyan (lt/hr m²) | 163.7 | 193.9 |
| Water flux rate - final (lt/hr m²) | 247.7 | 382.2 |

Preparation of Inks Dye 2, prior to filtration, (Comparative Ink 2) and the final concentrate of Dye 2 from the 50,000 Dalton filter (Ink 3) were converted into inks as described in Example 1.

### Ink-Jet Printing

Ink 3 and the Comparative Ink 2 were printed and the ΔE and % ROD loss were measured as described in Example 1. Results are shown in Table 5 where it is apparent that the print obtained from ink-jet printing Ink 3 is significantly more ozone stable than the print obtained with Comparative Ink 2.

TABLE 5

| | ΔE | % ROD Loss | ΔE | % ROD Loss |
|---|---|---|---|---|
| Ink | PR101 | PR101 | SEC PM | SEC PM |
| Ink 3 | 30 | 31% | 14 | 22% |
| Comparative Ink 2 | 34 | 40% | 18 | 27% |

### EXAMPLE 3

### Dye 3

Dye 3 was a form of C.I. Direct Blue 199 prepared according to WO03/078529

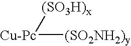

wherein x is 1.3 and y is 2.3.

### Fractionation of Dye 3

Dye 3 was filtered using the DDS M20 filtration unit. A solution of the dye (1.7%) was passed successively over 50,000 Dalton and 100,000 Dalton MWCO membranes, as described in Example 1. The conditions used are shown in Table 6.

TABLE 6
Summary of the fractionation process conditions of Dye 3
in the DDS M20 unit

| Membrane | 50 kD | 100 kD |
|---|---|---|
| Membrane Surface area (m²) | 0.18 | 0.18 |
| Time processing (hr) | 09:35 | 06:25 |
| Average Temperature (° C.) | 21 | 20 |
| Inlet operating pressure (bar) | 4 | 4 |
| Initial mass (g) in each stage | 222.5 | 137.33 |
| pH - initial | 8.3 | 7.8 |
| Water flux rate - initial (litre/hr m²) | 385.6 | 387.8 |
| Average flux rate - dye(litre/hr m²) | 94.4 | 105.6 |
| Water flux rate - final (litre/hr m²) | 238.9 | 237.2 |

### Preparation of Inks

Dye 3, prior to filtration, (Comparative Ink 3) and the Dye 3 concentrate from the 50,000 Dalton filter (Ink 4) were converted into inks as described above in Example 1.

### Ink-Jet Printing

Ink 4 and the Comparative Ink 3 were printed and the ΔE and % ROD loss were measured as described in Example 1. Results are shown in Table 7 where it is apparent that the print obtained from Ink 4 is significantly more ozone stable than the print obtained with Comparative Ink 3.

TABLE 7

| | ΔE | % ROD Loss | ΔE | % ROD Loss |
|---|---|---|---|---|
| | PR101 | PR101 | SEC PM | SEC PM |
| Ink 4 | 18 | 11% | 11 | 11% |
| Comparative Ink 3 | 23 | 16% | 13 | 16% |

1. A process for forming an image on a substrate comprising applying an ink thereto by means of an ink-jet printer wherein the ink comprises a liquid medium and a phthalocyanine dye fraction obtainable by the fractionation of a solution and/or suspension of a mixture of phthalocyanine dyes of Formula (1), and salts thereof, by cross-flow filtration: 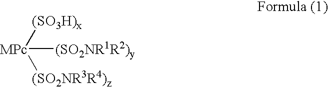
wherein:
M is 2H, copper or nickel;
Pc represents a phthalocyanine nucleus;
R¹ and R³ independently are H or optionally substituted C₁₋₄alkyl;
R² and R⁴ independently are H or optionally substituted hydrocarbyl; or
R¹ and R², and, R³ and R⁴, independently, together with the nitrogen atom to which they are attached represent an optionally substituted aliphatic or aromatic ring system;
x is 0 to 3.9;
y is 0 to 3.9;
z is 0.1 to 4; and
the sum of (x+y+z) is 2.4 to 4.5.

2. A process according to claim 1 wherein the substrate is paper.

3. A process according to either claim 1 or claim 2 wherein the substrate is photographic quality paper.

4. A process according to claim 1 wherein the ink has a viscosity of less than 20 cP at 25° C.; contains less than 500 ppm in total of divalent and trivalent metal ions (other than any divalent and trivalent metal ions bound to a component of the ink); contains less than 500 ppm halide ions; and
has been filtered through a filter having a mean pore size below 10 μm.

5. A process according to claim 1 where in the mixture of phthalocyanine dyes of Formula (1) M is Cu.

6. A process according to claim 1 where in the mixture of phthalocyanine dyes of Formula (1) R¹, R², and R³ are all H and R⁴ is hydroxyethyl.

7. A process according to claim 1 where in the mixture of phthalocyanine dyes of Formula (1) R³ is H, R⁴ is carboxyphenyl and y is 0.

8. A process according to claim 1 where in the mixture of phthalocyanine dyes of Formula (1) R³ and R⁴ are both H and y is 0.

9. A process according to claim 1 wherein the cross-flow filtration membrane is an ultrafiltration membrane.

10. A process according to claim 9 wherein the ultrafiltration membrane has a nominal molecular weight cut-off in the range of from 5,000 to 500,000.

11. A process according to claim 9 wherein the ultrafiltration membrane has a nominal molecular weight cut-off in the range of from 20,000 to 100,000.

12. A process according to claim 1 or claim 9 wherein cross-flow filtration is through a series of 2 or more membranes.

13. A printed substrate obtainable by means of a process as described in claim 1.

14. A printed substrate according to claim 13 which comprises paper.

15. A printed substrate according to either claim 13 or claim 14 which is a photographic quality print.

16. An ink-jet printing ink that comprises:
i) a phthalocyanine dye fraction obtainable by the fractionation of a solution and/or suspension of a mixture of phthalocyanine dyes of Formula (1) and salts thereof by cross-flow filtration: 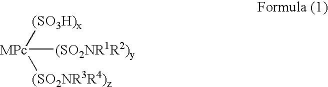
wherein:
M is 2H, copper or nickel;
Pc represents a phthalocyanine nucleus;
R¹ and R³ independently are H or optionally substituted C₁₋₄alkyl;
R² and R⁴ independently are H or optionally substituted hydrocarbyl; or
R¹ and R², and, R³ and R⁴, independently, together with the nitrogen atom to which they are attached represent an optionally substituted aliphatic or aromatic ring system;
x is 0 to 3.9;
y is 0 to 3.9;
z is 0.1 to 4; and
the sum of (x+y+z) is 4; and
(ii) a liquid medium:
wherein the ink has a viscosity of less than 20 cP at 25° C.; contains less than 500 ppm in total of divalent and trivalent metal ions (other than any divalent and trivalent metal ions bound to a component of the ink); contains less than 500 ppm halide ions; and has been filtered through a filter having a mean pore size below 10 μm.

17. An ink-jet printer cartridge comprising a chamber and an ink wherein the ink is in the chamber and the ink is as defined in claim 16.
